(19) United States
(12) Patent Application Publication
(10) Pub. No.: US 2021/0031151 A1
(43) Pub. Date: Feb. 4, 2021

(54) METHOD FOR MANUFACTURING HIGH-PERFORMANCE THIN FILM COMPOSITE MEMBRANE THROUGH THE SOLVENT ACTIVATION PROCESS

(71) Applicant: Korea University Research and Business Foundation, Seoul (KR)

(72) Inventors: Jung-hyun LEE, Seoul (KR); Min Gyu SHIN, Paju-si (KR); Sang Hee PARK, Seoul (KR); Hyoeun KWON, Seoul (KR); Soon Jin KWON, Daejeon (KR)

(73) Assignee: Korea University Research and Business Foundation, Seoul (KR)

(21) Appl. No.: 16/963,985

(22) PCT Filed: Jan. 22, 2019
(86) PCT No.: PCT/KR2019/000904

§ 371 Date: Jul. 22, 2020

(30) Foreign Application Priority Data
Jan. 22, 2018 (KR) 10-2018-0007918

(51) Int. Cl. B01D 69/12; B01D 61/02; B01D 71/56; B01D 67/00; C08G 69/26

(52) U.S. Cl. CPC B01D 69/125; B01D 61/027; C08G 69/26; B01D 71/56; B01D 67/0006; B01D 61/025

(57) ABSTRACT

The present invention relates to a method for manufacturing a high-performance thin film composite (TFC) membrane through post-treatment with solvents. In the present invention, Rₐ, which is a new criterion for activating solvents (difference in Hansen solubility parameter between an activating solvent and a polymer), and boiling points of the activating solvents are suggested, whereby the activating solvent thus selected can be used to implement the performance of reverse osmosis (RO) to nanofiltration (NF) grades, and an activated TFC membrane having anti-scaling effects to inorganic salts and acid resistance with high separation performance can be manufactured.

### TECHNICAL FIELD

The present invention relates to a method of manufacturing a high-performance thin film composite membrane through the solvent activation process.

### BACKGROUND ART

Thin film composite (TFC) membranes refer to separation membranes, which are semi-permeable and are composed of a selective layer that determines separation performance and a porous support that provides mechanical stability, and are currently used as a key material in the membrane separation processes for water treatment and seawater desalination. As a support of the TFC membrane, a porous polysulfone or polyethersulfone support having a surface pore size of 10 to 100 nm is generally used, and as a selective layer, polyamide-based materials are widely used. The selective layer is generally synthesized by interfacial polymerization of amine and acyl chloride monomers dissolved in two immiscible solvents such as water and n-hexane. It is common that selective layers with different structures are prepared using different types of amine monomers so as to realize the separation performance of the TFC membrane for a reverse osmosis (RO) or nanofiltration (NF) grade (Patent Document 1). Recently, efforts have been made to improve the separation performance of the TFC membrane by optimizing polymerization conditions, using various additives, or applying post-treatment with acids and organic solvents. For example, cases in which the separation performance of the thin film composite membrane is improved by post-treatment of a polyamide selective layer with an acid or organic solvent or by coating the same with dopamine, glycerin, or polyethylene glycol have been reported.

Among the cases, the post-treatment method with organic solvents referred to as a solvent activation process is known as a simple and effective method to improve the separation performance of the membrane. However, since polysulfone or polyethersulfone, which is a conventional support material of the TFC membrane, has poor organic solvent resistance, there is a limitation to the solvents that can be used for activation (Non-Patent Document 1). In addition, most solvent activation methods have the disadvantage in that the permeability of the TFC membrane is not significantly improved, or the salt rejection of the TFC membrane is significantly compromised. Therefore, there is a need for the development of a novel method that can solve these problems.

Patent Document 1. Korean Laid-Open Patent Publication No. 10-2012-0007276

Non-Patent Document 1. Journal of Membrane Science 286 (2006) 193-201

### DISCLOSURE

### Technical Problem

The present invention is directed to providing a Rₐ value (difference in Hansen solubility parameters (HSPs) between an polymer and an activating solvent) as a new criterion for choosing an activating solvent.

The present invention is also directed to providing a TFC membrane which is activated with an activating solvent satisfying the specific Rₐ value and thus capable of realizing various separation performance from a RO to NF grade and has anti-scaling properties against an inorganic salt and acid resistance.

### Technical Solution

One aspect of the present invention provides a method of manufacturing high-performance TFC membranes through solvent activation, which includes treating a membrane including a support and a selective layer formed on the support with an activating solvent, which has a Rₐ value of 10 or less, as calculated by the following Equation 1:

Rₐ=[4(δ_{d2}-δ_{d1})²+(δₚ₂-δₚ₁)² (δₕ₂-δₕ₁)²]^{0.5} <Equation 1>

In Equation 1, Rₐ is a difference in HSPs between the selective layer and the activating solvent, δ_{d} represents a dispersion force, δₚ represents a polar force, and δₕ represents a hydrogen bonding force between molecules.

Another aspect of the present invention provides a high-performance activated TFC membrane manufactured by the above-described method.

### Advantageous Effects

A method of manufacturing an activated TFC membrane according to the present invention can be easily applied to a conventional method of manufacturing a TFC membrane and allow a membrane to realize high RO or NF separation performance depending on the type of activating solvent. In addition, a TFC membrane according to the present invention can be applied in the fields of forward osmosis (FO), pressure retarded osmosis (PRO), and pressure assisted osmosis (PAO) as well as RO or NF.

In particular, in the present invention, the activated TFC membrane can be manufactured by selecting an optimal activating solvent and using an optimal solvent activation method. Accordingly, performance which is not realized by a conventional solvent activation process can be realized, and the activated TFC membrane having high water flux, excellent anti-scaling properties against inorganic salts (ionic material), and excellent acid resistance can be provided.

### DESCRIPTION OF DRAWINGS

FIG. 1 is a set of images illustrating the surface structure and surface roughness (rms roughness) value of TFC membranes activated with dimethyl sulfoxide (FIG. 1A) and benzyl alcohol (FIG. 1B) manufactured in examples of the present invention and a pristine TFC membrane (FIG. 1C) manufactured in a comparative example (scale bar=1 μm).

FIG. 2 shows the result of a long-term operating test of a TFC membrane activated with benzyl alcohol manufactured in examples of the present invention.

FIG. 3 shows the result of an scaling test of a TFC membrane activated with dimethyl sulfoxide manufactured in examples of the present invention.

FIG. 4 shows the result of an acid resistance test of TFC membranes manufactured in examples of the present invention.

### MODES OF THE INVENTION

Hereinafter, a method of manufacturing solvent-activated TFC membranes according to the present invention will be described in detail.

The manufacturing method according to the present invention includes treating a membrane including a support and a selective layer formed on the support with an activation solvent. In the present invention, the treatment with organic solvents may be referred to as “solvent activation” or “solvent activation process”.

The membrane including a support and a selective layer formed on the support is usable as a TFC membrane. In addition, TFC membranes treated with activating solvents will be designated as activated TFC membranes or TFC membranes activated with activating solvents.

In the present invention, the support serves to support the selective layer and enhance the mechanical strength of a TFC membrane. The support may have a porous structure.

As a support, a commercially available product or a synthesized product may be used. The support may be formed of one or more polymers selected from the group consisting of polyethylene, polyimide, polybenzimidazole, polyacrylonitrile, Teflon, polypropylene, polyether ether ketone (PEEK), sulfonated polyether ether ketone (S-PEEK), and polyvinylidene fluoride or a derivative thereof.

In an embodiment, the support may be a polyethylene support. Such a polyethylene support may be formed of a polyethylene resin or a resin including polyethylene and polypropylene, polymethylpentene, polybutene-1, or a mixture thereof. When the support is formed by further including polypropylene, polymethylpentene, polybutene-1, or a mixture thereof in addition to the polyethylene, mechanical properties and the like may be improved.

Since the polyethylene is cheaper than other materials, has excellent porosity and excellent pore connectivity due to its interconnected pore structures, and achieves excellent mechanical strength even with a low thickness, it may be readily used as the support of the TFC membrane. In addition, since the polyethylene has excellent thermal and chemical stability, it may be utilized in various environmental conditions by maximizing the durability of the membrane. In particular, since the polyethylene has excellent stability against organic solvents, the structure of the support may not be destroyed but maintained even during an activation process using various organic solvents. In addition, due to high porosity and excellent pore connectivity, high separation performance may be realized in the manufacture of the TFC membrane, and a selective layer with high stability and high selectivity may be formed on the support due to uniform pores.

In an embodiment, when a polyethylene support is used as the support, the polyethylene support may be prepared by a wet process.

In general, a polyolefin-based support such as a polyethylene support is prepared by a dry process based on a stretching process or a wet process based on an extraction process.

When the polyethylene support is prepared by a dry process, since the support is stretched perpendicularly to a stretching direction, a pore size is not uniform, and porosity and pore connectivity are not excellent, and it is difficult to adjust thickness. Accordingly, it is not easy to form the selective layer in the manufacture of the membrane.

Therefore, a polyethylene support which has a uniform thickness and a uniform pore size and exhibits excellent porosity and excellent pore connectivity may be prepared using a wet process. Due to the uniform pore size, it is possible to prepare a high-performance selective layer, and due to high porosity and excellent pore connectivity, permeation resistance is minimized, thereby making it possible to manufacture a TFC membrane with high water flux and high selectivity.

In an embodiment, the polyethylene support may be prepared by melt-extruding and stretching a polyethylene resin and a diluent. In addition, in the present invention, the polyethylene support may be prepared by melt-extrusion and stretching processes further using polypropylene, polymethylpentene, polybutene-1, or a mixed resin thereof in addition to the polyethylene resin and the diluent.

Through the method, pores are formed by phase separation or cracking at an interface between crystals, and strength is ensured by the stretching process, thereby making it easy to form the selective layer on the support.

The polyethylene resin may have a weight-average molecular weight of 100,000 to 1,000,000 gmol⁻¹. Within the above-described range, the mechanical strength and durability of the prepared support can be improved.

In an embodiment, the diluent may be an organic liquid compound that is thermally stable at an extrusion temperature, such as an aliphatic or cyclic hydrocarbon (e.g., nonane, decane, decalin, paraffin oil, or the like), a phthalic acid ester (e.g., dibutyl phthalate, dioctyl phthalate, or the like), or the like.

The polyethylene resin and the diluent may be included at 20 to 50 wt % and 50 to 80 wt % relative to 100 wt % of the entire support, respectively. Within the above-described ranges, excellent kneading properties between the polyethylene resin and the diluent are achieved, the polyethylene resin is not thermodynamically kneaded with the diluent, and a support with excellent stretchability can be prepared.

In addition, in the present invention, an inorganic material may be further included. As an inorganic material, silicon dioxide (SiO₂), aluminum oxide (Al₂O₃), calcium carbonate (CaCO₃), titanium dioxide (TiO₂), silicon sulfide (SiS₂), magnesium oxide (MgO), zinc oxide (ZnO), barium titanate (BaTiO₃), or a mixture thereof may be used. The inorganic material may have an average particle size of 0.01 to 5 μm. Within the above-described range, the support can exhibit excellent strength, and the pore size after stretching is suitable for application in the manufacture of a membrane.

In addition, in the present invention, common additives for improving specific functions, such as an antioxidant, a UV stabilizer, an antistatic agent, an organic/inorganic nucleating agent, and the like, may be further included as necessary.

In an embodiment, the polyethylene support may be prepared by inputting a polyethylene resin and a diluent in an extruder, kneading and extruding the same to prepare a melt, subjecting the melt to liquid-liquid phase separation by passing the melt through a section in which an extrusion temperature is equal to or lower than a liquid-liquid phase separation temperature to prepare a sheet, stretching the sheet, and extracting the diluent from the stretched sheet. After the extraction of the diluent, a drying process may be further performed.

In an embodiment, the support may have a thickness of 1 to 30 μm, 1 to 20 μm, 1 to 18 μm, or 5 to 10 μm. Within the above-described thickness range, excellent performance as a membrane for a RO or NF process can be realized. Even when the thickness of the support is more than 30 μm, physical properties and performance that are required for use as a membrane are achieved, but water flux may decrease, and manufacturing costs may increase. Therefore, it is preferable to adjust the thickness of the support to 1 to 30 μm.

In an embodiment, the support may have a pore size of 0.1 μm or less or 10 to 100 nm. Within the above-described size range, the compactness of the selective layer is not degraded, and thus a membrane with excellent salt rejection can be provided. When the pore size of the support is more than 0.1 μm, pinhole defects may occur in the selective layer, and salt (NaCl) rejection of 97% or more may not be achieved.

In an embodiment, the support may have a porosity (void fraction) of 20 to 70%, 30 to 70%, 40 to 70%, or 50 to 70%. When the above-described range, an excellent permeate flow rate can be achieved, and the support can exhibit excellent strength.

In an embodiment, the support may have a water contact angle of 120° or less or 100° or less and a surface free energy of 30 mJm⁻² or more or 35 mJm⁻² or more. Within the above-described ranges, excellent performance as a membrane can be achieved.

In addition, in the present invention, when the TFC membrane is applied in RO process, a value obtained by multiplying the thickness of the support by the tensile strength may be 0.3 kgf/cm or more or 0.3 to 10 kgf/cm. The value may be obtained in one or more of the longitudinal and transverse directions of the support. Within the above-described range, the support can support a RO operating pressure.

The manufacturing method according to the present invention may further include hydrophilizing the support before the selective layer is formed on the support.

The hydrophilization treatment results in an increase in surface energy, and thus the bonding strength of the support with the selective layer may be increased. Such hydrophilization treatment may be performed on one surface or both surfaces of the support, and when the hydrophilization treatment is performed on one surface, the surface on which the selective layer is to be formed may be hydrophilized. Generally, since the support is hydrophobic, the hydrophilization treatment may facilitate the formation of the selective layer.

Such hydrophilization treatment may be performed by chemical oxidation, plasma oxidation, UV oxidation, atomic layer deposition (ALD), chemical vapor deposition (CVD), inorganic coating, or polymer coating.

The chemical oxidation may use an acidic solution containing hydrochloric acid, sulfuric acid, nitric acid, hydrogen peroxide, or sodium hypochlorite or a basic solution containing sodium hydroxide, potassium hydroxide, or ammonium hydroxide, and the plasma oxidation may allow one surface or both surfaces of the support to be treated. The inorganic coating may use copper oxide, zinc oxide, titanium oxide, tin oxide, aluminum oxide, or the like as an inorganic material, and the polymer coating may use a hydrophilic compound such as polyhydroxyethylenemethacrylate, polyacrylic acid, polyhydroxymethylene, polyallylamine, polyaminostyrene, polyacrylamide, polyethylenimine, polyvinyl alcohol, polydopamine, or the like as a polymer.

In the present invention, after the hydrophilization treatment, washing the support may be further included. As a solvent used in the washing, isopropyl alcohol, water, or a mixed solvent thereof may be used.

In the present invention, the selective layer is formed on the support. The selective layer is a high-density thin film and has a smooth surface.

In an embodiment, the selective layer may include one or more selected from the group consisting of aliphatic or aromatic polyamide, aromatic polyhydrazide, polybenzimidazolone, polyepiamine/amide, polyepiamine/urea, polyethylenimine/urea, sulfonated polyfuran, polybenzimidazole, polypiperazine isophthalamide, polyether, polyether urea, polyester, and polyimide.

In an embodiment, the selective layer may have a thickness of 1 to 10,000 nm.

In the present invention, the selective layer may be formed by an interfacial polymerization method, a dip coating method, a spray coating method, a spin coating method, a layer-by-layer assembly method, or a dual slot coating method. In the present invention, the selective layer may be formed by an interfacial polymerization method.

In an embodiment, the formation of the selective layer by an interfacial polymerization method may include:

impregnating or coating the support with a first solution containing a first organic monomer;

adjusting an amount of the first organic monomer on the support;

impregnating or coating the support with a second solution containing a second organic monomer;

forming a selective layer by interfacial polymerization of the first organic monomer and the second organic monomer dissolved in the first solution and the second solution, respectively; and removing the residual second organic monomer.

In an embodiment, there is no particular limitation on the type of the first organic monomer, and, for example, one or more selected from the group consisting of m-phenylenediamine (MPD), o-phenylenediamine (OPD), p-phenylenediamine (PPD), piperazine, m-xylenediamine (MXDA), ethylenediamine, trimethylenediamine, hexamethylenediamine, diethylenetriamine (DETA), triethylenetetramine (TETA), methanediamine (MDA), isophoronediamine (IPDA), triethanolamine, polyethylenimine, methyl diethanolamine, hydroxyalkyl amine, hydroquinone, resorcinol, catechol, ethylene glycol, glycerine, polyvinyl alcohol, 4,4′-biphenol, methylene diphenyl diisocyanate, m-phenylene diisocyanate, p-phenylene diisocyanate, and toluene diisocyanate, all of which have an amine or hydroxyl group, may be used as the first organic monomer.

In an embodiment, there is no particular limitation on the type of the solvent of the first solution, and, for example, one or more selected from the group consisting of water, methanol, ethanol, propanol, butanol, isopropanol, ethyl acetate, acetone, chloroform, tetrahydrofuran, dimethyl sulfoxide, dimethylformamide, and N-methyl-2-pyrrolidone may be used as the solvent of the first solution.

In addition, in the present invention, the first solution may further contain a surfactant to improve the wettability of the support with the first solution.

As such a surfactant, an ionic or non-ionic surfactant may be used, and the ionic surfactant may be an anionic, cationic, or amphoteric surfactant.

In an embodiment, as the anionic surfactant, one or more selected from the group consisting of ammonium lauryl sulfate, sodium 1-heptanesulfonate, sodium hexanesulfonate, sodium dodecyl sulfate, triethanolammonium dodecylbenzene sulfate, potassium laurate, triethanolamine stearate, lithium dodecyl sulfate, sodium lauryl sulfate, alkyl polyoxyethylene sulfate, sodium alginate, dioctyl sodium sulfosuccinate, phosphatidylglycerol, phosphatidylinositol, phosphatidylserine, phosphatidic acid and salts thereof, glyceryl ester, sodium carboxymethyl cellulose, bile acid and salts thereof, cholic acid, deoxycholic acid, glycocholic acid, taurocholic acid, glycodeoxycholic acid, alkyl sulfonate, aryl sulfonate, alkyl phosphate, alkyl phosphonate, stearic acid and salts thereof, calcium stearate, phosphate, carboxymethyl cellulose sodium, dioctyl sulfosuccinate, dialkyl esters of sodium sulfosuccinate, phospholipids, and calcium carboxymethyl cellulose may be used. As the cationic surfactant, one or more selected from the group consisting of quaternary ammonium compounds, benzalkonium chloride, cetyltrimethyl ammonium bromide, chitosan, lauryl dimethyl benzyl ammonium chloride, acylcarnitine hydrochloride, alkylpyridinium halide, cetylpyridinium chloride, cationic lipid, polymethylmethacrylate trimethyl ammonium bromide, sulfonium compounds, polyvinylpyrrolidone-2-dimethylaminoethyl methacrylate dimethyl sulfate, hexadecyltrimethyl ammonium bromide, phosphonium compounds, benzyl-di(2-chloroethyl)ethyl ammonium bromide, coconut trimethyl ammonium chloride, coconut trimethyl ammonium bromide, coconut methyl dihydroxyethyl ammonium chloride, coconut methyl dihydroxyethyl ammonium bromide, decyl triethyl ammonium chloride, decyl dimethyl hydroxyethyl ammonium chloride bromide, (C₁₂-C₁₅)dimethyl hydroxyethyl ammonium chloride, (C₁₂-C₁₅)dimethyl hydroxyethyl ammonium chloride bromide, coconut dimethyl hydroxyethyl ammonium chloride, coconut dimethyl hydroxyethyl ammonium bromide, myristyl trimethyl ammonium methylsulfate, lauryl dimethyl benzyl ammonium chloride, lauryl dimethyl benzyl ammonium bromide, lauryl dimethyl (ethenoxy)4 ammonium chloride, lauryl dimethyl (ethenoxy)4 ammonium bromide, N-alkyl (C₁₂-C₁₈)dimethyl benzyl ammonium chloride, N-alkyl (C₁₄-C₁₈)dimethyl benzyl ammonium chloride, N-tetradecyldimethylbenzyl ammonium chloride monohydrate, dimethyl didecyl ammonium chloride, N-alkyl (C₁₂-C₁₄)dimethyl 1-naphthylmethyl ammonium chloride, trimethyl ammonium halide alkyl-trimethyl ammonium salts, dialkyl-dimethyl ammonium salts, lauryl trimethyl ammonium chloride, ethoxylated alkylamidoalkyldialkyl ammonium salts, ethoxylated trialkyl ammonium salts, dialkylbenzene dialkyl ammonium chloride, N-didecyldimethyl ammonium chloride, N-tetradecyldimethylbenzyl ammonium chloride monohydrate, N-alkyl(C₁₂-C₁₄) dimethyl 1-naphthylmethyl ammonium chloride, dodecyl dimethyl benzyl ammonium chloride, dialkyl benzene alkyl ammonium chloride, lauryl trimethyl ammonium chloride, alkyl benzyl methyl ammonium chloride, alkyl benzyl dimethyl ammonium bromide, C₁₂ trimethyl ammonium bromide, C₁₅ trimethyl ammonium bromide, C₁₇ trimethyl ammonium bromide, dodecylbenzyl triethyl ammonium chloride, polydiallyldimethyl ammonium chloride, dimethyl ammonium chloride, alkyldimethyl ammonium halogenide, tricetyl methyl ammonium chloride, decyltrimethyl ammonium bromide, dodecyltriethyl ammonium bromide, tetradecyltrimethyl ammonium bromide, methyl trioctyl ammonium chloride, tetrabutyl ammonium bromide, benzyl trimethyl ammonium bromide, choline esters, benzalkonium chloride, stearalkonium chloride, cetylpyridinium bromide, cetylpyridinium chloride, alkyl pyridinium salts, amines, amine salts, imidazolium salts, cationic guar gum, benzalkonium chloride, dodecyltrimethyl ammonium bromide, triethanolamine, and poloxamine may be used. As the amphoteric surfactant, one or more selected from the group consisting of N-dodecyl-N,N-dimethyl-3-ammonio-1-propanesulfonate, betaine, alkyl betaine, alkylamido betaine, amido propyl betaine, cocoamphocarboxyglycinate, sarcosinate aminopropionate, aminoglycinate, imidazolinum betaine, amphoteric imidazoline, N-alkyl-N,N-dimethylammonio-1-propanesulfonate, 3-cholamido-1-propyl dimethylammonio-1-propanesulfonate, dodecylphosphocholine, and sulfobetaine may be used. In addition, as the non-ionic surfactant, one or more selected from the group consisting of Span 60, polyoxyethylene fatty alcohol ether, polyoxyethylene sorbitan fatty acid ester, polyoxyethylene fatty acid ester, polyoxyethylene alkyl ether, polyoxyethylene castor oil derivatives, sorbitan esters, glyceryl ester, glycerol monostearate, polyethylene glycol, polypropylene glycol, polypropylene glycol ester, cetyl alcohol, cetostearyl alcohol, stearyl alcohol, arylalkyl polyether alcohol, a polyoxyethylene-polyoxypropylene copolymer, poloxamers, poloxamine, methylcellulose, hydroxycellulose, hydroxymethylcellulose, hydroxyethylcellulose, hydroxypropylcellulose, hydroxypropylmethylcellulose, hydroxypropylmethylcellulose phthalate, amorphous cellulose, polysaccharides, starch, starch derivatives, hydroxyethyl starch, polyvinyl alcohol, triethanolamine stearate, amine oxide, dextran, glycerol, acacia gum, cholesterol, tragacanth, and polyvinylpyrrolidone may be used.

In an embodiment, the first solution may contain the first organic monomer at 0.1 to 10 wt % or 1 to 5 wt % and the surfactant at 0.01 to 2 wt % or 0.03 to 0.1 wt %.

The use of the surfactant is associated with the morphological change of the selective layer. In particular, since sodium dodecyl sulfate (SDS) serves to lower the interfacial tension between immiscible aqueous-organic phases, the first organic monomer may be easily diffused to an organic phase, that is, the second solution. Accordingly, the interface reaction region is enlarged, and the polymerization reaction is promoted, which may affect the surface roughness and thickness of the selective layer. That is, as the content of the surfactant is increased, the surface roughness and thickness of the selective layer may be increased. As the thickness of the selective layer is increased, permeability is generally decreased due to high transport resistance, and on the other hand, as the surface roughness of the selective layer is increased, solvent permeability is increased due to an increased surface area. Therefore, when a properly adjusted amount of the surfactant is used, a TFC membrane with excellent performance may be manufactured.

In an embodiment, there is no particular limitation on the type of the second organic monomer, and, for example, one or more selected from the group consisting of trimesoyl chloride (TMC), terephthaloyl chloride, isophthaloyl chloride, cyclohexane-1,3,5-tricarbonyl chloride, 5-isocyanato-isophthaloyl chloride, cyanuric chloride, trimellitoyl chloride, phosphoryl chloride, and glutaraldehyde may be used as the second organic monomer.

In an embodiment, there is no particular limitation on the type of the solvent of the second solution, and, for example, one or more selected from the group consisting of n-hexane, pentane, cyclohexane, heptane, octane, carbon tetrachloride, benzene, xylene, toluene, chloroform, tetrahydrofuran, and isoparaffin may be used as the solvent of the second solution.

In an embodiment, the second organic monomer may be included at 0.01 to 1 wt % or 0.1 to 0.5 wt % in the second solution.

In the present invention, the above-described first solution contains an amine monomer, and the above-described second solution contains an acyl chloride monomer. Accordingly, a polyamide selective layer may be synthesized by interfacial polymerization of the monomers.

In an embodiment, the adjustment of a residual amount of the first organic monomer on the support is for removing the excess first solution on the surface of the support and may be performed using an air gun or a roller.

In addition, the manufacturing method according to the present invention may further include, after the formation of a selective layer, washing the selective layer.

In the present invention, the membrane including the support on which the selective layer has been formed is manufactured by the above-described process.

In the present invention, after the manufacture of the membrane, the membrane is treated with an activating solvent. Specifically, in the present invention, the support on which the selective layer has been formed (i.e., membrane including support and the selective layer formed on the support) may be treated with an activating solvent.

Through the solvent-activation process, a TFC membrane, which is capable of realizing various separation performance from a RO to NF grade and has high water flux, anti-scaling properties against inorganic salts, and acid resistance, may be manufactured.

When the TFC membrane is treated with the activating solvent, small polyamide fragments and unreacted monomers which are present in the selective layer after interfacial polymerization are removed. Specifically, when the selective layer is brought into contact with the activating solvent, the selective layer may be swollen due to the solvency power of the activating solvent, so that residual polyamide fragments and unreacted monomers could be dissolved out, resulting in the structural changes of the selective layer. Accordingly, the water flux and salt rejection of the TFC membrane may be controlled.

In an embodiment, the activating solvent may have a Rₐ value of 10 or less or 9 or less, as calculated by the following Equation 1. The lower limit of the value may be 0 or 0.1.

Rₐ=[4(δ_{d2}-δ_{d1})²+(δₚ₂-δₚ₁)²+(δₕ₂-δ^{h1})²]^{0.5} <Equation 1>

In Equation 1, Rₐ is a difference in HSPs between the selective layer and the activating solvent and may be indicated in the unit of MPa^{1/2}. δ_{d} represents a dispersion force, δₚ represents polar force, and δₕ represents a hydrogen bonding force between molecules. The HSPs were suggested by C. M. Hansen and means that the cohesive energy terms of solubility parameter (SP, intrinsic material properties, which are expressed as the square root of the cohesive energy density of the material (gas, liquid, solid)) values suggested by Hildebrand are classified according to the kind of interaction energy that works between molecules of each material, and the HSPs are represented by a dispersion force term (δ_{d}), a dipolar intermolecular force term (δₚ), and a hydrogen bond strength term (δₕ). For example, the HSPs of aromatic polyamide are δ_{d}=18.0 MPa^{1/2, δ}ₚ=11.9 MPa^{1/2}, and δₕ=7.9 MPa^{1/2}. In Equation 1, subscript 1 may refer to the HSPs corresponding to the polyamide selective layer, and subscript 2 may refer to the HSPs corresponding to the activating solvent.

In the present invention, the Rₐ value may vary depending on the area of application of the activated TFC membrane. When the activated TFC membrane is applied in RO process, the activating solvent may have a Rₐ value of 7 to 10 or 8 to 10, and when applied in nanofiltration (NF), the activating solvent may have a Rₐ value of 7 or less or 8 or less.

In general, the structural change of the selective layer may be inversely proportional to the Rₐ value. As the Rₐ value is lower, the internal structure of the selective layer may be significantly deformed due to high solvency power of the activating solvent for the polyamide. That is, as the Rₐ value is lower, salt rejection may be decreased, while water flux may be significantly enhanced due to the severe structural changes of the selective layer.

In an embodiment, the activating solvent may have a boiling point of 100° C. or more. When the activating solvent has a boiling point of less than 100° C., the activating solvent is very rapidly evaporated during the solvent activation process, and thus there may be a problem in process stability, and the membrane may also be damaged.

That is, in the present invention, the activating solvent having a Rₐ value of 10 or less and a boiling point of 100° C. or more may be used to optionally manufacture an activated TFC membrane with more excellent separation performance.

In an embodiment, the activating solvent may be one or more selected from the group consisting of benzyl alcohol, dimethyl sulfoxide, N,N-dimethylformamide, dimethylacetamide, and N-methyl-2-pyrrolidone.

In the present invention, the solvent activation process may be performed for 24 hours or less, 10 hours or less, or 1 hour or less. The activating solvent of the present invention exerts an effect immediately after starting the treatment. When the treatment is performed for 24 hours or more, no further treatment effect may be obtained, and thus process efficiency may be decreased. Therefore, it is preferable to perform the treatment for 24 hours or less in terms of process efficiency.

In addition, the solvent activation process may be performed at 10 to 100° C. or 25 to 90° C. In general, the temperature is inversely proportional to the activation time, and as the temperature is higher, the activation time may be reduced. However, since the activation effect and the freezing point and boiling point of the activating solvent vary depending on the type of activating solvent, and the glass transition temperature varies depending on the type of the support used, it is preferable to perform the solvent activation process at 25 to 100° C. in consideration of these facts.

In addition, the solvent activation process may be performed using a surface contact, supporting, soaking, air spraying, or permeation method.

In addition, the present invention relates to a preparation method of pristine and activated TFC membranes by the above-described method.

The activated TFC membrane according to the present invention has high water flux, excellent anti-scaling properties against inorganic salts, and excellent acid resistance.

In particular, in the present invention, since the pristine and activated TFC membranes are manufactured using a polyethylene support as a support and performing a solvent activation process, excellent pore characteristics of the polyethylene support and a material property improvement resulting from the solvent activation process may be combined to provide a superior effect.

Such an activated TFC membrane may be applied to a FO, PRO, PAO, RO, or NF process.

In particular, in the present invention, the TFC membrane may be applied to a RO process or a NF process. The activated TFC membrane according to the present invention may have salt rejection required in a RO or a NF process even at low pressure and exhibit a high water flux and high acid resistance. Therefore, the activated TFC membrane may also be suitably used as a membrane under acidic conditions.

In an embodiment, when the activated TFC membrane is applied to a RO process, the process pressure may be 30 to 40 bar. In addition, under conditions of a flow rate of 1 L min⁻¹, a pressure of 15.5 bar, a 2,000 ppm MgSO₄, Na₂SO₄, MgCl₂, or NaCl aqueous solution, water permeance may be 2 to 8 L m⁻²h⁻¹ bar⁻¹ or 3 to 6 L m⁻²h⁻¹ bar⁻¹, and salt rejection may be 90% or more, 95% or more, or 99% or more.

In an embodiment, when the activated TFC membrane is applied to a NF process, the process pressure may be 10 bar or less or 5 bar or less. In addition, under process conditions of a flow rate of 0.5 L min⁻¹, a pressure of 10 bar, a 1,000 ppm MgSO₄, Na₂SO₄, MgCl₂, or NaCl aqueous solution, water permeance may be 9 to 20 L m⁻² h⁻¹ bar⁻¹ or 10 to 18 L m⁻² h⁻¹ bar⁻¹, and alt rejection may be 90% or more, 95% or more, or 99% or more.

Hereinafter, the present invention will be described in detail with reference to examples of the present invention. However, the following examples are merely presented to exemplify the present invention, and the content of the present invention is not limited to the following examples.

### EXAMPLES

### Examples 1 to 5 and Comparative Examples 1 and 2. Manufacture of a TFC membrane

1) Porous Support

A commercially available polyethylene membrane (W-SCOPE Corporation) having a surface pore size of 20 to 50 nm or a commercially available polyacrylonitrile ultrafiltration membrane (Sepro Membranes Inc.) having a surface pore size of about 15 nm was used.

Specifically, the commercially available polyethylene membrane was used as a support in Experimental Example 1 and (1), (2), (4), and (5) of Experimental Example 2, and the commercially available polyacrylonitrile ultrafiltration membrane was used as a support in (3) of Experimental Example 2.

2) Preparation of a Selective Layer

Water was used as the first solvent (hydrophilic solvent) of the first solution, and m-phenylenediamine (MPD) was used as the first organic monomer included in the first solution. As a surfactant included in the first solution, sodium dodecyl sulfate (SDS) was used.

n-hexane was used as the second solvent (organic solvent) of the second solution, and trimesoyl chloride (TMC) was used as the second organic monomer included in the second solution.

In addition, as an activating solvent (see Table 1 below) for adjusting the separation performance of a TFC membrane to be manufactured, benzyl alcohol, dimethyl sulfoxide, N,N-dimethylformamide, dimethylacetamide, or N-methyl-2-pyrrolidone, which has a Rₐ value of 10 or less and a boiling point of 100° C. or more, was used.

Meanwhile, the validity of the selection criteria for the activating solvents used in the present invention was verified by using isopropyl alcohol having a Rₐ value of 10 or more and a boiling point of 100° C. or less and acetone having a Rₐ value of 10 or less and a boiling point of 100° C. or less as an activating solvent.

TABLE 1

| | | Boiling point | Rₐ |
|---|---|---|---|
| | Activating solvent | (° C.) | (MPa^{1/2}) |
| Example 1 | Benzyl alcohol | 205 | 8.1 |
| Example 2 | N,N-dimethylformamide | 153 | 4.03 |
| Example 3 | Dimethylacetamide | 165 | 3.35 |
| Example 4 | Dimethyl sulfoxide | 189 | 5.12 |
| Example 5 | N-methyl-2-pyrrolidone | 202 | 0.81 |
| Comparative | Isopropyl alcohol | 83 | 11.2 |
| Example 1 | | | |
| Comparative | Acetone | 56 | 5.3 |
| Example 2 | | | |

The selective layer was prepared by interfacial polymerization as follows.

(1) A support was washed with isopropyl alcohol and water.

(2) The washed support was immobilized in a reaction container, and the first solution containing SDS at 0.05 wt % and MPD at 3 wt % was added to impregnate the support with the first solution.

(3) The excess first solution on the support surface was removed, and the second solution containing TMC at 0.15 wt % was spread onto the MPD-impregnated support, thereby synthesizing a polyamide selective layer by polymerization of monomers at the interface.

(4) Unreacted second organic monomers were removed by washing with the solvent used in the second solution, and drying was performed.

3) Solvent Activation Process

A solvent activation process was performed as follows.

(1) The TFC membrane dried in the step 2) was allowed to be brought into contact with an activating solvent.

(2) After being brought into contact with the activating solvent at room temperature (25° C.) for 10 minutes, the membrane was washed with distilled water.

(3) The washed membrane was stored in distilled water until the performance thereof was measured.

### Comparative Example 3

A pristine TFC membrane was manufactured in the same manner as in Examples except that the 3) solvent activation process was not performed.

### Comparative Example 4

A commercially available RO membrane (SWC4+ manufactured by Hydranautics Corporation) was used.

### Comparative Example 5

A commercially available NF membrane (NF270 manufactured by DOW FILMTEC) was used.

### Experimental Example 1

### Surface Structure of Membrane Manufactured through the Solvent Activation Process

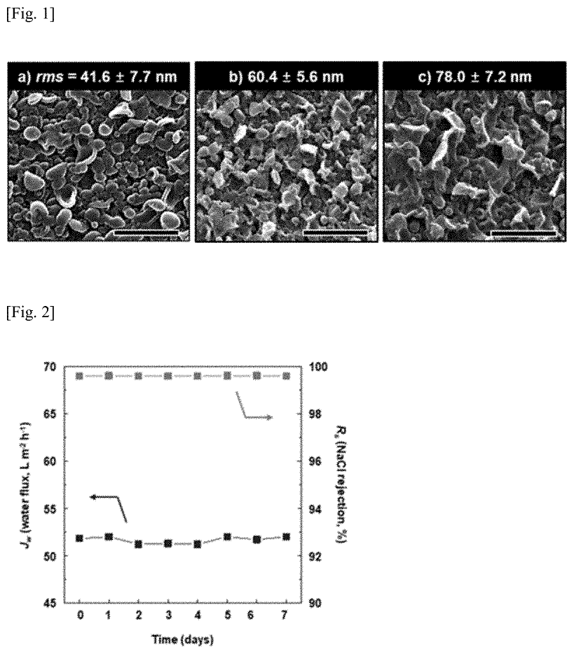

FIG. 1 shows the surface structures of pristine and activated TFC membranes.

Specifically, FIG. 1 shows the surface structures of TFC membranes activated with dimethyl sulfoxide (FIG. 1A) and benzyl alcohol (FIG. 1B) as an activating solvent and a pristine TFC membrane (FIG. 1C) manufactured in Examples and Comparative Example 3.

As shown in FIG. 1, all of the membranes manufactured in Examples and Comparative Example 3 showed a rough surface structure, but the surface rms roughness thereof was reduced as the Rₐ value of the activating solvent decreased. This results from the structural changes of the selective layer and/or the dissolution of polyamide fragments in the polyamide selective layer through the solvent activation process.

### Experimental Example 2

### Performance experiment

To confirm RO performance, a permeation test was performed under process conditions of a flow rate of 1 L min⁻¹, a pressure of 15.5 bar, and a 2,000 ppm MgSO₄, Na₂SO₄, MgCl₂, or NaCl aqueous solution, and to confirm NF performance, a permeation test was performed under process conditions of a flow rate of 0.5 L min⁻¹, a pressure of 10 bar, and a 1,000 ppm MgSO₄, Na₂SO₄, MgCl₂, or NaCl aqueous solution, thereby evaluating water permeance and salt rejection. In addition, both types of performance were evaluated at 25±0.5° C.

(1) Performance Results of Membranes Manufactured using Polyethylene Supports with the Solvent Activation Process

Performance evaluation results are shown in the following Table 2.

TABLE 2

| | Applied | | Water permeance | Salt rejection (%) | | | |
|---|---|---|---|---|---|---|---|
| | process | Activating solvent | (A, L m⁻² h⁻¹ bar⁻¹) | MgSO₄ | Na₂SO₄ | MgCl₂ | NaCl |
| Example 1 | RO | Benzyl alcohol | 4.0 | 99.9 | 99.9 | 99.9 | 99.6 |
| Example 2 | NF | N,N-dimethylformamide | 13.0 | 99.9 | 99.9 | 98.8 | 87.8 |
| Example 3 | NF | Dimethylacetamide | 12.5 | 99.9 | 99.9 | 98.8 | 88.8 |
| Example 4 | NF | Dimethyl sulfoxide | 16.5 | 99.9 | 99.9 | 98.8 | 86.4 |
| Example 5 | NF | N-methyl-2-pyrrolidone | 10.0 | 99.9 | 99.9 | 98.7 | 90.5 |
| Comparative Example 1 | RO | Isopropyl alcohol | 1.8 | 99.9 | 99.9 | 99.9 | 99.4 |
| Comparative Example 2 | RO | Acetone | 2.0 | 99.9 | 99.9 | 99.9 | 99.3 |
| Comparative Example 3 | RO | — | 1.7 | 99.9 | 99.9 | 99.8 | 99.6 |
| (untreated membrane) | | | | | | | |
| Comparative Example 4 | RO | — | 1.5 | 99.9 | 99.9 | 99.5 | 99.1 |
| (commercially available | | | | | | | |
| RO membrane) | | | | | | | |
| Comparative Example 5 | NF | — | 12.0 | 98.1 | 99.0 | 65.0 | 65.0 |
| (commercially available | | | | | | | |
| NF membrane) | | | | | | | |

As shown in Table 2, when the activating solvent according to the present invention, that is, the activating solvent having a Rₐ value of 10 or less and a boiling point of 100° C. or more was used, it was possible to adjust separation performance from a RO to NF grade through the solvent activation process.

In particular, Comparative Example 1 and Comparative Example 2, which satisfy only one of two activating solvent conditions (Rₐ value: 10 or less, boiling point: 100° C. or more), showed excellent salt rejection but low water permeance. From this result, it can be seen that when an activating solvent satisfying both conditions of a Rₐ value of 10 or less and a boiling point of 100° C. or more is used, a TFC membrane with excellent water permeance and excellent salt rejection which are desired in the present invention can be manufactured.

In addition, when the pristine and activated TFC membranes according to the present invention were compared with a commercially available RO membrane SWC4+ (Comparative Example 4) and a commercially available NF membrane NF270 (Comparative Example 5), the activated TFC membranes exhibited superior water permeance and salt rejection.

This result indicates that the separation performance of the TFC membrane can be improved by the solvent activation process and can be suitably adjusted for the purpose of the membrane according to the type of the activating solvent.

(2) Long-Term Operation Results of the TFC Membrane Activated with Benzyl Alcohol

In the present invention, FIG. 2 is a graph illustrating the result of long-term operation of the TFC membrane activated with benzyl alcohol.

As shown in FIG. 2, the result of long-term operation of the TFC membrane activated with benzyl alcohol showed no change in performance under the RO operation condition for 7 days.

This result indicates that the solvent activation process of the present invention permanently improves separation performance. In addition, this stable performance result indicates that the application of the solvent activation process is applicable in industrial fields.

(3) Performance Results of Membranes Manufactured using Polyacrylonitrile Support According to the Solvent Activation Process

Performance evaluation results are shown in the following Table 3.

TABLE 3

| | | Treatment | | |
|---|---|---|---|---|
| | | time | Water flux | NaCl |
| | Solvent | (min) | (J_{w}, L m⁻² h⁻¹) | rejection (%) |
| Example 1 | Benzyl | 0 | 23.3 | 99.8 |
| | alcohol | 10 | 58.9 | 99.8 |

This experiment confirmed that a change in the properties of the polyamide selective layer was attributed to the solvent activation process of the present invention.

As shown in Table 3, it was possible to apply the solvent activation process of the present invention to not only a polyethylene support but also all supports having resistance to an activating solvent, such as a polyacrylonitrile support.

Based on this result, it is expected that the solvent activation process of the present invention is applicable more widely.

(4) Anti-Scaling Property of the Activated TFC Membrane against Inorganic Salt

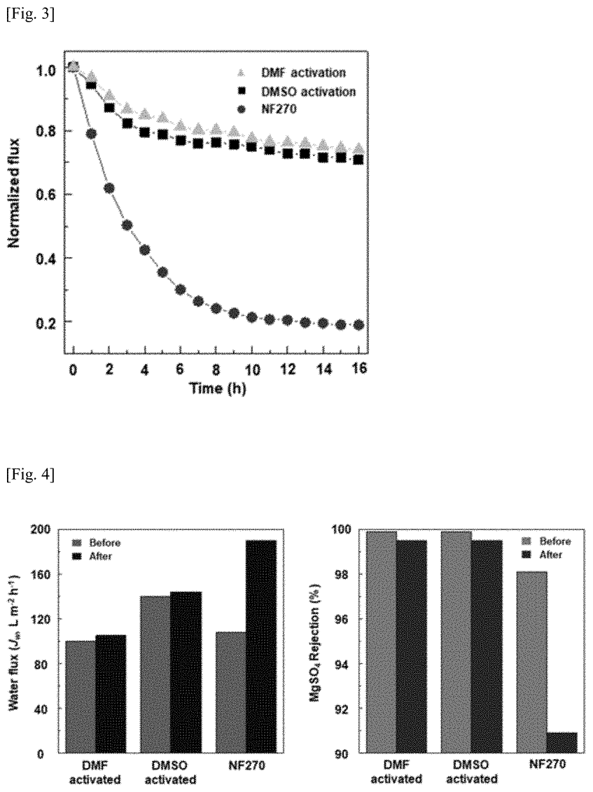

FIG. 3 is a graph illustrating the anti-scaling properties of an activated TFC membrane using a polyethylene support against an inorganic salt. Specifically, FIG. 3 shows the result of a scaling test of the TFC membrane activated with dimethyl sulfoxide (NF grade) among TFC membranes manufactured in Examples of the present invention.

When compared with a commercially available NF membrane NF270 (Comparative Example 5) under the same operation condition, the TFC membrane exhibited an at least 50% higher anti-scaling effect. Based on this result, it can be seen that the activated TFC membrane of the present invention exhibits both excellent performance and excellent anti-scaling effects against an inorganic salt.

(5) Acid Resistance of Activated TFC Membrane

FIG. 4 is a graph illustrating the acid resistance of an activated TFC membrane using a polyethylene support. Specifically, FIG. 4 shows the results of evaluating the acid resistance of the TFC membrane activated with dimethyl sulfoxide or dimethylformamide in Examples of the present invention. The activated TFC membrane was immersed in a 15 wt % aqueous H₂SO₄ solution for 24 hours, and then separation performance before and after the acid treatment was compared.

As a result, the TFC membrane activated with dimethyl sulfoxide or dimethylformamide exhibited excellent acid resistance compared to a commercially available NF membrane NF270 (Comparative Example 5) and showed slightly increased water flux and a slight change in salt rejection before and after the solvent activation.

Based on this result, it can be seen that the activated TFC membrane of the present invention is applicable in the separation process under strong acid conditions.

### INDUSTRIAL APPLICABILITY

A method of manufacturing an activated TFC membrane according to the present invention can be easily applied to a conventional method of manufacturing a TFC membrane and allow a membrane to realize high RO or NF separation performance depending on the type of the activating solvent. In addition, an activated TFC membrane according to the present invention can be applied in the fields of FO, PRO, PAO as well as the RO or NF.

1. A method of manufacturing process for an activated thin film composite (TFC) membrane, referred to as a solvent activation process, comprising:
treating a membrane including a support and a selective layer formed on the support with an activating solvent,
wherein the activating solvent has a Rₐ value of 10 or less, as calculated by the following Equation 1:
Rₐ=[4(δ_{d2}-δ_{d1})²+(δₚ₂-δₚ₁)²+(δₕ₂-δₚ₁)²]^{0.5} <Equation 1>
in Equation 1, Rₐ is a difference in Hansen solubility parameters between the selective layer and the activating solvent,
δ_{d} represents a dispersion force between molecules,
δₚ represents a polar force between molecules, and
δₕ represents a hydrogen bonding force between molecules.

2. The method of claim 1, wherein the support is formed of one or more polymers selected from the group consisting of polyethylene, polyimide, polybenzimidazole, polyacrylonitrile, Teflon, polypropylene, polyether ether ketone (PEEK), sulfonated polyether ether ketone (S-PEEK), and polyvinylidene fluoride or a derivative thereof

3. The method of claim 1, wherein the support is formed of polyethylene.

4. The method of claim 1, wherein the selective layer includes one or more selected from the group consisting of aliphatic or aromatic polyamide, aromatic polyhydrazide, polybenzimidazolone, polyepiamine/amide, polyepiamine/urea, polyethylenimine/urea, sulfonated polyfuran, polybenzimidazole, polypiperazine isophthalamide, polyether, polyether urea, polyester, and polyimide.

5. The method of claim 1, wherein the selective layer is formed by an interfacial polymerization method, a dip coating method, a spray coating method, a spin coating method, a layer-by-layer assembly method, or a dual slot coating method.

6. The method of claim 1, wherein the selective layer is formed by:
impregnating or coating the support with the first solution containing the first organic monomer;
adjusting an amount of the first organic monomer on the support;
impregnating or coating the support with the second solution containing the second organic monomer;
forming a selective layer by interfacial polymerization of the first organic monomer and the second organic monomer which are dissolved in the first solution and the second solution, respectively; and
removing the residual second organic monomer.

7. The method of claim 6, wherein the first organic monomer is one or more selected from the group consisting of m-phenylenediamine (MPD), o-phenylenediamine (OPD), p-phenylenediamine (PPD), piperazine, m-xylenediamine (MXDA), ethylenediamine, trimethylenediamine, hexamethylenediamine, diethylenetriamine (DETA), triethylenetetramine (TETA), methanediamine (MDA), isophoronediamine (IPDA), triethanolamine, polyethylenimine, methyl diethanolamine, hydroxyalkyl amine, hydroquinone, resorcinol, catechol, ethylene glycol, glycerine, polyvinyl alcohol, 4,4′-biphenol, methylene diphenyl diisocyanate, m-phenylene diisocyanate, p-phenylene diisocyanate, and toluene diisocyanate.

8. The method of claim 6, wherein a solvent of the first solution is one or more selected from the group consisting of water, methanol, ethanol, propanol, butanol, isopropanol, ethyl acetate, acetone, chloroform, tetrahydrofuran, dimethyl sulfoxide, dimethylformamide, and N-methyl-2-pyrrolidone.

9. The method of claim 6, wherein the first solution may further contain a surfactant.

10. The method of claim 6, wherein the second organic monomer is one or more selected from the group consisting of trimesoyl chloride (TMC), terephthaloyl chloride, isophthaloyl chloride, cyclohexane-1,3,5-tricarbonyl chloride, 5-isocyanato-isophthaloyl chloride, cyanuric chloride, trimellitoyl chloride, phosphoryl chloride, and glutaraldehyde.

11. The method of claim 6, wherein a solvent of the second solution is one or more selected from the group consisting of n-hexane, pentane, cyclohexane, heptane, octane, carbon tetrachloride, benzene, xylene, toluene, chloroform, tetrahydrofuran, and isoparaffin.

12. The method of claim 1, wherein the activating solvent has a boiling point 100° C. or more.

13. The method of claim 1, wherein the activating solvent is one or more selected from the group consisting of benzyl alcohol, dimethyl sulfoxide, N,N-dimethylformamide, dimethylacetamide, and N-methyl-2-pyrrolidone.

14. The method of claim 1, wherein the solvent activation process is performed for 24 hours or less.

15. The method of claim 1, wherein the solvent activation process is performed at 10 to 100° C.

16. The method of claim 1, wherein the solvent activation process is performed using a surface contact, supporting, soaking, air spraying, or permeation method.

17. A activated TFC membrane manufactured by the method of claim 1.

18. The TFC membrane of claim 17, which is applied to a reverse osmosis (RO), forward osmosis (FO), pressure retarded osmosis (PRO), pressure assisted osmosis (PAO), or nanofiltration (NF) process.
